(19) United States
(12) Patent Application Publication
(10) Pub. No.: US 2026/0119644 A1
(43) Pub. Date: Apr. 30, 2026

(54) UNIFIED GOVERNANCE OF ARTIFICIAL INTELLIGENCE AGENTS

(71) Applicant: BOOMI, LP, Conshohocken, PA (US)

(72) Inventors: Steven LUCAS, Denver, CO (US); Edward MACOSKY, Livermore, CA (US); Thomas BENJAMIN, Foster City, CA (US); Sandeep SINGH, Cumming, GA (US); Ayush PARASHAR, Foster City, CA (US); Ashish RANJAN, Bangalore (IN); Omar AZOOKARI, Hoover, AL (US)

(73) Assignee: BOOMI, LP, Conshohocken, PA (US)

(21) Appl. No.: 19/010,551

(22) Filed: Jan. 6, 2025

(30) Foreign Application Priority Data
Oct. 25, 2024 (IN) 202411081537

(51) Int. Cl. G06F 21/52

(52) U.S. Cl. CPC G06F 21/52

(57) ABSTRACT

There is no unified, comprehensive system for the governance of artificial intelligence (AI) agents. Accordingly, disclosed embodiments register a plurality of AI agents, potentially from disparate sources, into a centralized registry. Prior to activation, each AI agent is associated with a governance policy. After activation, each AI agent is monitored in real time, during execution, to determine whether or not the AI agent remains compliant with the associated governance policy. When an AI agent becomes non-compliant with the associated governance policy, corrective action may be taken, and the AI agent may be labeled as untrusted. The corrective action may comprise alerting a user, modifying the AI agent, adjusting an amount of each of one or more computational resources that is allocated to the AI agent, modifying an access of the AI agent to one or more systems, adjusting a communication control of the AI agent, and/or the like.

### CROSS-REFERENCE TO RELATED APPLICATIONS

The present application claims priority to Indian Provisional Patent Application No. 202411081537, filed on Oct. 25, 2024, which is hereby incorporated herein by reference as if set forth in full.

### BACKGROUND

### Field of the Invention

The embodiments described herein are generally directed to artificial intelligence, and, more particularly, to the unified governance of artificial intelligence (AI) agents.

### Description of the Related Art

Integration Platform as a Service (iPaaS) enables the integration of applications and data. The iPaaS platform provided by Boomi® of Conshohocken, Pennsylvania, enables users to construct integration processes from pre-built steps, visually represented as “shapes,” which each has a set of configuration properties. Each step dictates how an integration process retrieves data, manipulates data, routes data, sends data, and/or the like. These steps can be connected together in endless combinations to build simple to very complex integration processes.

An artificial intelligence (AI) agent is a software entity that utilizes artificial intelligence (e.g., machine learning, natural-language processing, data analytics, etc.) to autonomously perform a task, in order to achieve a goal set by a human, other AI agent, or other system. An AI agent may collect data, analyze data, learn and improve, communicate with human users and/or other software entities, collaborate with other AI agents to complete a complex task, execute actions, and/or the like. Advantages of AI agents include, without limitation, enhanced efficiency, improved customer satisfaction, perpetual availability, scalability, data-driven insight, consistency, accuracy, and the like.

AI agents may be utilized within an iPaaS platform to autonomously perform integration-related tasks, such as customer support, software design, code generation, conversational assistance, and the like. For example, an AI agent could be used to automatically map and/or transform data, orchestrate and/or optimize workflows, identify patterns and predict potential issues with integration processes, detect and/or resolve errors in integration processes, design steps in an integration process and/or entire integration processes based on a natural-language input from a user, otherwise interact with users through natural language, dynamically scale and adjust integration processes and/or the runtimes in which they execute, detect and/or mitigate security threats or compliance risks, identify and protect personally identifiable information, discover application programming interfaces (APIs), optimize API calls, monitor parameters of integration processes and/or integration platforms in real time for real-time alerts, provide next-step best practices, document integration processes (e.g., for improved version control), provide technical support, streamline data synchronization, enhance data quality, and/or the like.

AI governance has become an increasing concern with the proliferation of AI technologies, including AI agents. AI governance refers to the frameworks, policies, practices, and tools that guide the ethical development, deployment, and utilization of artificial intelligence. The primary goal of AI governance is to ensure that artificial intelligence operates transparently, responsibly, and in accordance with societal values and laws, as well as organizational objectives.

State-of-the-art AI-governance systems typically operate in isolated environments, with a focus on specific aspects of management, such as regulatory compliance or performance monitoring. These traditional approaches often rely on manual processes for risk assessment and compliance checks, which leads to fragmented oversight and delayed responses to potential issues. Some solutions attempt to address AI governance through siloed tools for each different aspect of AI management. These state-of-the-art AI-governance systems lack a unified, comprehensive approach. In addition, state-of-the-art AI-governance systems have struggled to keep pace with the rapidly evolving regulatory landscape and the increasing complexity of artificial intelligence.

### SUMMARY

Accordingly, systems, methods, and non-transitory computer-readable media are disclosed for the unified governance of artificial intelligence (AI) agents. Embodiments provide a cohesive structure that facilitates real-time monitoring, risk-profiling, and regulatory compliance of AI agents. Integration of these capabilities with an iPaaS platform may enhance transparency, accountability, and ethical management of AI agents, while streamlining operational processes.

In an embodiment, a method comprises using at least one hardware processor to: associate each of a plurality of artificial intelligence (AI) agents with a respective governance policy, prior to activation of the AI agent within an integration platform as a service (iPaaS) platform; and for each of the plurality of AI agents, after activation of the AI agent, monitor the AI agent, in real time as the AI agent is executing, by determining whether or not the AI agent is compliant with the associated respective governance policy, and when determining that the AI agent is not compliant with the associated respective governance policy, automatically executing a corrective action, and labeling the AI agent as untrusted.

The method may further comprise using the at least one hardware processor to, for each of the plurality of AI agents, monitor the AI agent, in real time as the AI agent is executing, by further: determining whether or not the AI agent is behaving anomalously; and when determining that the AI agent is behaving anomalously, automatically executing the corrective action, and labeling the AI agent as untrusted.

The method may further comprises using the at least one hardware processor to, for each of the plurality of AI agents, determine a value of a governance effectiveness index that quantifies an effectiveness of governance of the AI agent across a plurality of dimensions. The plurality of dimensions may comprise risk management, reliability, ethical alignment, performance, and security and privacy. For each of the plurality of AI agents, determining the value of the governance effectiveness index may comprise calculating the value of the governance effectiveness index according to:

$${w}_{1} \times RM + {w}_{2} \times RE + {w}_{3} \times EA + {w}_{4} \times PF + {w}_{5} \times SP$$

wherein w₁, w₂, w₃, w₄, and w₅ are weights, RM is a risk management score that quantifies an adequacy of a risk management strategy for the AI agent, RE is a reliability score that quantifies a reliability of the AI agent, EA is an ethical alignment score that quantifies how well the AI agent adheres to ethical guidelines, PF is a performance score that quantifies a performance of the AI agent in task execution, and SP is a security and privacy score that quantifies how well the AI agent is protected against data breaches and complies with privacy regulations.

The method may further comprise using the at least one hardware processor to, for each type of the plurality of AI agents, generate a standardized connector framework for the generation of connector steps to be used by integration processes on the iPaaS platform to communicate with any one of the plurality of AI agents of that type.

At least one of the respective governance policies may comprise at least one data privacy protocol. At least one of the respective governance policies may comprise at least one compliance standard.

The method may further comprise using the at least one hardware processor to, for each of the plurality of AI agents, establish a baseline value for each of one or more performance metrics for the AI agent.

The corrective action may comprise modifying the AI agent. Modifying the AI agent may comprise one or more of: terminating execution of the AI agent; deactivating the AI agent; adjusting at least one parameter of the AI agent; detecting and correcting a bias in the AI agent; or rolling back the AI agent to a previous version. The corrective action may comprise adjusting an amount of each of one or more computational resources that is allocated to the AI agent. The corrective action may comprise modifying an access of the AI agent to one or more systems. Modifying the access of the AI agent to one or more systems may comprise one or more of: restricting access by the AI agent to an application programming interface; restricting access by the AI agent to at least one data source; adjusting an authentication level required from the AI agent; revoking a credential of the AI agent; or downgrading at least one permission assigned to the AI agent. The corrective action may comprise adjusting a communication control associated with the AI agent. Adjusting the communication control of the AI agent may comprise one or more of: limiting a rate by which at least one application programming interface can be called; or adjusting a response timeout associated with the AI agent.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for the unified governance of artificial intelligence (AI) agents, according to an embodiment;

FIG. 4 illustrates a process for the unified governance of AI agents, according to an embodiment; and

FIG. 5 illustrates a process for monitoring AI agents, according to an embodiment.

### DETAILED DESCRIPTION

In an embodiment, systems, methods, and non-transitory computer-readable media are disclosed for the unified governance of artificial intelligence (AI) agents. Disclosed embodiments provide enhanced oversight and management of AI agents across diverse computational environments. For example, structured methodologies, derived from the National Institute of Standards and Technology (NIST) AI Risk Management Framework (AI RMF), may be used to systematically capture key performance metrics, risk profiles, and/or compliance parameters of the AI agents. With the increasing complexity and autonomy of AI agents, disclosed embodiments emphasize unified AI governance, real-time risk management, and compliance monitoring across organizations.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

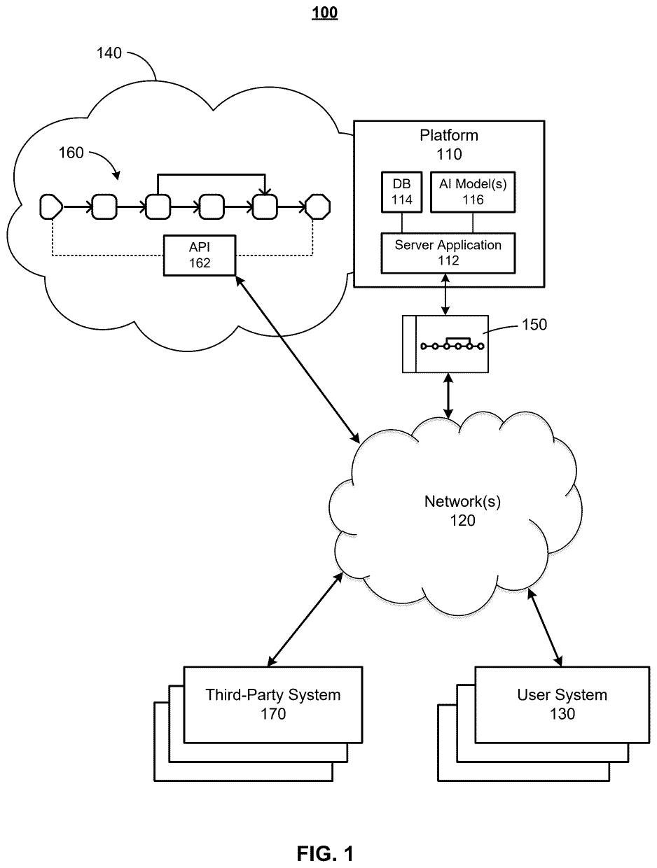

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. In particular, platform 110 may execute a server application 112, host a database 114 that may store data used by server application 112, and/or execute one or more artificial intelligence AI models 116 that may process data generated by server application 112 and/or stored in database 114 and/or generate data for use by server application 112 and/or storage in database 114. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and user system(s) 130. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 through a single set of network(s) 120, it should be understood that platform 110 may be connected to different user systems 130 via different sets of one or more networks. For example, platform 110 may be connected to a subset of user systems 130 via the Internet, but may be connected to another subset of user systems 130 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of an integration developer that has a user account for accessing server application 112 on platform 110. It should be understood that the integration developer may be anywhere from a novice, with little to no prior experience in integration development, to an expert, with many years of experience in integration development. When platform 110 is an integration platform as a service (iPaaS) platform, each user account may be associated with an overarching organizational account for managing an integration platform on the iPaaS platform.

Server application 112 may manage an integration environment 140. In particular, server application 112 may provide a user interface 150 and backend functionality, including one or more of the processes disclosed herein, to enable users, via user systems 130, to construct, develop, modify, save, delete, test, deploy, un-deploy, and/or otherwise manage integration processes 160 within integration environment 140. User interface 150 may comprise a graphical user interface that implements a low-code environment, including potentially a no-code environment, in which users may construct integration processes 160.

The user of a user system 130 may authenticate with platform 110 using standard authentication means, to access server application 112 in accordance with permissions or roles of the associated user account. The user may then interact with server application 112 to manage one or more integration processes 160, for example, within a larger integration platform within integration environment 140. It should be understood that multiple users, on multiple user systems 130, may manage the same integration process(es) 160 and/or different integration processes 160 in this manner, according to the permissions or roles of their associated user accounts.

Although only a single integration process 160 is illustrated, it should be understood that, in reality, integration environment 140 may comprise any number of integration processes 160, including tens, hundreds, tens of hundreds, thousands, tens of thousands, hundreds of thousands, millions, tens of millions, hundreds of millions, billions, or more integration processes 160. In an embodiment, integration environment 140 supports integration platform as a service. In this case, integration environment 140 may comprise one or a plurality of integration platforms that each comprises one or a plurality of integration processes 160. Each integration platform may be associated with an organization, which may be associated with one or more user accounts by which respective user(s) manage the organization's integration platform, including the various integration process(es) 160.

An integration process 160 may represent a transaction involving the integration of data between two or more systems, and may comprise a series of elements that specify logic and transformation requirements for the data to be integrated. Each element, which may also be referred to herein as a “step” and have a visual representation referred to herein as a “shape,” may transform, route, and/or otherwise manipulate data to attain an end result from input data. For example, a basic integration process 160 may receive data from one or more data sources (e.g., via an application programming interface 162 of the integration process 160), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process 160 may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

The functionality of server application 112 may include a process for constructing an integration process 160 within one or more screens of a graphical user interface of user interface 150. Embodiments of such functionality are disclosed, for example, in U.S. Pat. No. 8,533,661, issued on Sep. 10, 2013, which is hereby incorporated herein by reference as if set forth in full. In particular, this application describes functionality that enables the construction of integration processes 160 on a virtual canvas.

Each integration process 160, when deployed, may be communicatively coupled to network(s) 120. For example, each integration process 160 may comprise an application programming interface (API) 162 that enables clients to access integration process 160 via network(s) 120. A client may push data to integration process 160 through application programming interface 162, and/or pull data from integration process 160 through application programming interface 162.

One or more third-party systems 170 may be communicatively connected to network(s) 120, such that each third-party system 170 may communicate with an integration process 160 in integration environment 140 via application programming interface 162. Third-party system 170 may host and/or execute a software application that pushes data to integration process 160 and/or pulls data from integration process 160, via application programming interface 162. Additionally or alternatively, an integration process 160 may push data to a software application on third-party system 170 and/or pull data from a software application on third-party system 170, via an application programming interface of the third-party system 170. Thus, third-party system 170 may be a client or consumer of one or more integration processes 160, a data source for one or more integration processes 160, and/or the like. As examples, the software application on third-party system 170 may comprise, without limitation, enterprise resource planning (ERP) software, customer relationship management (CRM) software, accounting software, and/or the like.

### 2. Example Processing System

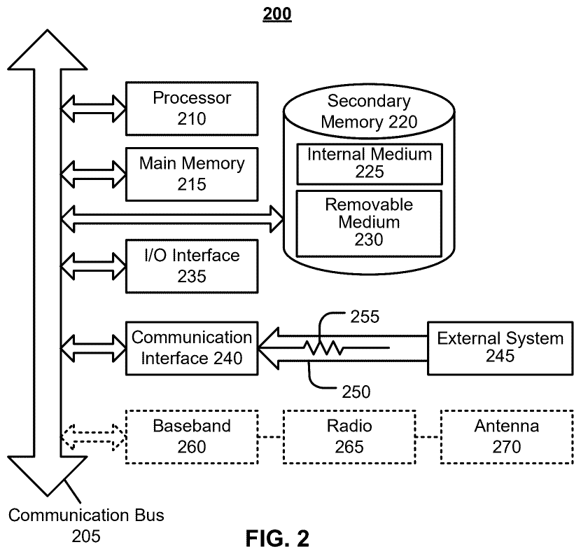

FIG. 2 illustrates an example processing system, by which one or more of the processes described herein may be executed, according to an embodiment. For example, system 200 may be used to store and/or execute server application 112 and/or AI model 116, store database 114, and/or may represent components of platform 110, user system(s) 130, third-party system 170, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Data Flow

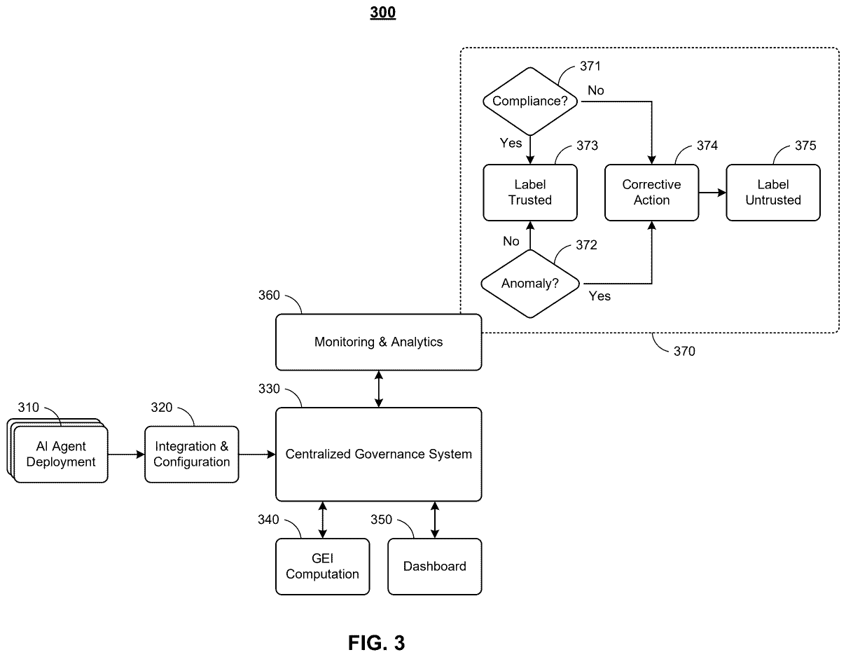

FIG. 3 illustrates an example data flow 300 for the unified governance of AI agents, according to an embodiment. In data flow 300, server application 112 may implement modules 320, 330, 340, and 360, user interface 150 may implement module 350, and server application 112 and/or one or more third-party systems 170 may implement module 310. All of the modules are preferably implemented as software modules, but could also be implemented as hardware modules or as modules comprising a combination of hardware and software.

Each module 310, which may be implemented by server application 112 or third-party software on a third-party system 170, represents the deployment of an AI agent. An AI agent may be deployed locally on platform 110 or remotely on a third-party system 170, including potentially in a cloud-computing environment. Each AI agent may communicate with a local software entity on platform 110 via an application programming interface. For example, the local software entity may push or pull data through the application programming interface of the AI agent, or the AI agent may push or pull data through the application programming interface of the local software entity. A local software entity may comprise or consist of an integration process 160, server application 112, user interface 150 (e.g., a graphical user interface), and/or the like. Each AI agent may be located, and potentially accessible via an application programming interface of the AI agent, at a network address, such as an Internet Protocol (IP) address, uniform resource locator (URL), and/or the like.

In an embodiment, server application 112 may comprise a web crawler that crawls websites of AI agent providers. Examples of such providers include, without limitation, OpenAI™, Google Cloud AI™, Microsoft Azure AI™, IBM Watson Assistant™, Amazon Web Services™, Boston Dynamics AI™, Nvidia AI™, Zendesk AI™, Genesys AI™, Ada™, Cognigy™, Rasa™, Replika™, Anthropic™, and the like. The web crawler may crawl the websites of these providers, and extract and store data about each AI agent offered by these providers, including the specification of each AI agent. The specification of an AI agent may comprise the objective of the AI agent, external tool(s) used by the AI agent, a network address of the AI agent, an application programming interface of the AI agent, function(s) provided by the AI agent, parameter(s) of the AI agent, the architecture of the AI model used by the AI agent, the input schema for inputs to the AI agent, the output schema for outputs of the AI agent, system requirements of the AI agent, dependencies of the AI agent, performance metrics for the AI agent (e.g., accuracy, response time, scalability, reliability, etc.), ethical guardrails (i.e., boundaries) of the AI agent, authentication requirements for the AI agent, operational constraints on the AI agent, test cases for verifying the AI agent's functionality, and/or the like.

Module 320, which may be implemented by server application 112, may, for each of a plurality of AI agents deployed via module(s) 310, integrate the AI agent into platform 110, which may be an iPaaS platform, and determine a configuration for the AI agent. It should be understood that these AI agents may have been developed by different developers, according to different frameworks and design factors, and therefore, may vary significantly in terms of structures, application programming interfaces, performance metrics, reliability, compliance standards, ethical principles, cybersecurity risk, privacy risk, and/or the like. Since there is no unified, comprehensive standard for the development of AI agents, the plurality of AI agents may be very diverse across numerous dimensions.

Integration of each AI agent into platform 110 may comprise determining a standardized connector framework for the type of AI agent. In particular, module 320 may, for each type of AI agent in the plurality of AI agents, generate a standardized connector framework for generation of connector steps to be used by integration processes 160 on platform 110 to communicate with any one of the plurality of AI agents of that type. Thus, module 320 may, whenever a new AI agent has been deployed (e.g., for which a specification was returned by the web crawler), determine the type of the new AI agent and whether or not a standardized connector framework already exists for that type of AI agent. If so, module 320 may associate that existing standardized connector framework with the new AI agent. Otherwise, module 320 may generate a new standardized connector framework, and associate the new standardized connector framework with the new AI agent, as well as the type of the new AI agent. The standardized connector framework may canonicalize the protocols for a plurality of different providers of AI agents into a single internal protocol that can be used internally by platform 110. In particular, a user may generate a connector step, within an integration process 160, for communication with an AI agent by specifying configurable parameters that are the same for all AI agents of the same type, and which are combined with the standardized connector framework to generate the connector step.

Configuration of the AI agent may comprise implementing authentication with the AI agent using one or more protocols, potentially including a multi-factor protocol. In other words, the authentication layer for each AI agent may be configured. The configuration of the AI agent may also comprise establishing the value of each of one or more baseline performance metrics for the AI agent. The baseline metric(s) may be established using metric seeding. Metric seeding refers to the process of initializing or designing metrics that guide the evaluation of the AI agent's performance and represent measurable criteria that define the success or failure of the AI agent at performing a particular task and/or achieving a particular goal. The configuration of the AI agent may further comprise configuring the AI agents, which may exist in various environments (e.g., a cloud-computing environment, on-premises environment, hybrid cloud-computing and on-premises environment, etc.), to report one or more metrics and/or activities to monitoring and analytics module 360 in real time. As used herein, the terms “real time” and “real-time” refer to events that occur simultaneously, as well as events that are temporally separated from each other by ordinary and/or unintended latencies in processing, memory access, communications, and/or the like.

Centralized governance system 330 represents the core of data flow 300. Centralized governance system 330 may utilize module 320 to ingest data related to AI agents (e.g., the AI agent specifications extracted by the web crawler of server application 112 or pushed to server application 112), deployed via module(s) 310, to produce a registry or catalog of all AI agents that may be used on platform 110. Centralized governance system 330 may associate each registered AI agent with a unique identifier to be used for that AI agent within platform 110. The registry provides a simplified, normalized (e.g., standardized specification and terminologies), and unified view of all available AI agents. Centralized governance system 330 may autonomously govern the AI agents in the registry within a unified framework, potentially using one or more supporting modules, such as modules 340 and 360. Centralized governance system 330 may also provide a dashboard 350 within a graphical user interface, provided by user interface 150, through which users can manage their respective AI agents. For example, module 360 may monitor and collect information about the AI agents, which may be fed back into centralized governance system 330, and dynamically reported to users via dashboard 360 (e.g., with a governance effectiveness index computed by module 340, and/or other operational metrics).

Centralized governance system 330 may associate each of the plurality of AI agents with a respective governance policy, prior to activation of the AI agent within platform 110, which may be an iPaaS platform. In other words, each AI agent must be assigned a governance policy before it can be activated within platform 110. In an embodiment, centralized governance system 330 may comprise an attachment mechanism that attaches a governance policy to each AI agent. The attachment mechanism may automatically select a governance policy from among a plurality of available governance policies based on one or more criteria (e.g., the type of AI agent, ethical guardrails in the specification of the AI agent, and/or other attributes of the AI agent), prompt a user to select the governance policy from among a plurality of available governance policies or otherwise specify the governance policy, recommend a governance policy for selection by a user based on a recommendation engine, and/or the like. Notably, the assignment of governance policies from among predefined governance policies facilities the distribution and enforcement of a standard set of governance policies across the AI ecosystem.

A governance policy may comprise one or more data privacy protocols, one or more compliance standards, one or more privacy techniques, and/or the like. Examples of data privacy protocols include, without limitation, the General Data Protection Regulation (GDPR), the California Consumer Privacy Act (CCPA), the Health Insurance Portability and Accountability Act (HIPAA), the Personal Information Protection and Electronic Documents Act (PIPEDA), the Family Educational Rights and Privacy Act (FERPA), and/or the like. Examples of compliance standards includes, without limitation, the NIST Cybersecurity Framework, the NIST Privacy Framework, the International Organization for Standardization (ISO)/International Electrotechnical Commission (IEC) 27001 standard, the ISO/IEC 27701 standard, the Payment Card Industry Data Security Standard (PCI DSS), the Cybersecurity Maturity Model Certification (CMMC), the Control Objectives for Information and Related Technology (COBIT), the Center for Internet Security (CIS) Controls, and/or the like. Examples of privacy techniques include, without limitation, data encryption, anonymization of personally identifiable information (PII), data classification, sensitivity-level analysis, access-level management, data-flow monitoring, and/or the like. Some data privacy protocols, compliance standards, and/or privacy techniques may relate to data in general, whereas others may be industry-specific. Thus, a governance policy may be crafted to each AI agent, based on the industry implicated by the AI agent.

Centralized governance system 330 may also associate each of the plurality of AI agents with one or more monitoring parameters. These monitoring parameters may comprise performance metrics, ethical metrics, and/or other metrics to be tracked for the AI agent. These monitoring parameters may also define how frequently these metrics are to be collected for the AI agent. The monitoring parameters may also defined one or more thresholds or ranges for values of these metrics that represent compliance and/or non-compliance with the governance policy associated with the AI agent and/or that represent normal and/or anomalous behavior by the AI agent.

As mentioned above, centralized governance system 330 may implement a recommendation engine for the governance policy to be associated with a given AI agent. For example, the recommendation engine may comprise a machine-learning model that is trained on historical associations between AI agents and governance policies. These historical associations may be crowd-sourced from a plurality of integration platforms managed through and executed by an iPaaS platform, such as the Boomi® iPaaS platform. The iPaaS platform may support a plurality of integration platforms, each managed by a different organizational account that is associated with one or more user accounts. In this case, the historical associations, between AI agents and governance policies, may represent a massive repository that is very diverse and includes potentially thousands, tens of thousands, hundreds of thousands, millions, tens of millions, hundreds of millions, billions, or more associations. The recommendation engine may be trained to receive one or more attributes of an AI agent as an input (e.g., from the specification and/or configuration of the AI agent), and output an identifier of a governance policy or a confidence value for each of a plurality of potential governance policies to be assigned to the AI agent. In this case, the recommendation engine may be trained using a training dataset that comprises a plurality of records that each comprises a feature vector, including values for the one or more attributes of the AI agent, and is labeled with a target governance policy. The recommendation engine may comprise an artificial neural network (e.g., a deep-learning neural network (DNN), recurrent neural network (RNN), graph neural network (GNN), or the like), a random forest algorithm, a linear regression algorithm, a logistic regression algorithm, a decision tree, a support vector machine (SVM), a naïve Bayes algorithm, a k-Nearest Neighbors (kNN) algorithm, a K-means algorithm, a dimensionality reduction algorithm, a gradient-boosting algorithm, a Markov chain, a compact prediction tree (CPT), and/or the like.

Centralized governance system 330 may also define one or more weights to be used by module 340. In particular, as discussed in greater detail elsewhere herein, module 340 may compute a governance effectiveness index for each of the plurality of AI agents in the registry of centralized governance system 330. The computation of the governance effectiveness index may utilize one or more weights that may define the contribution of one or more dimensions to the governance effectiveness index. In this case, the weights may be tuned (e.g., manually by a user) to optimize the governance effectiveness index, according to one or more design factors.

Centralized governance system 330 may also define one or more corrective actions that may be implemented by monitoring and analytics module 360. The defined corrective actions represent actions that are available to module 360 to correct an issue with an AI agent, such as non-compliance with the governance policy associated with that AI agent, anomalous behavior by the AI agent, and/or the like. In an embodiment, module 360 cannot perform any corrective action that is not defined in centralized governance system 330. Examples of corrective actions include, without limitation, alerting a user, modifying an AI agent (e.g., at the model level), adjusting an amount of each of one or more computational resources that is allocated to an AI agent, modifying an access of an AI agent to one or more systems, adjusting a communication control of an AI agent, and/or the like. Alerting a user may comprise sending a notification, such as an internal message within user interface 150 (e.g., to be displayed on dashboard 350), an electronic mail message, a text message, a voice message, and/or the like, to a user that is responsible for the AI agent. Modifying an AI agent may comprise terminating execution of the AI agent, deactivating the AI agent (e.g., de-registering or de-listing the AI agent from the registry), adjusting at least one parameter of the AI agent, detecting and/or correcting a bias (e.g., predictions of the AI agent are skewed towards a particular outcome) in the AI agent, rolling back the AI agent to a previous version, updating the AI agent to a new version, and/or the like. Adjusting an amount of computational resource(s) allocated to an AI agent may comprise increasing or decreasing the processing power allocated to the AI agent (e.g., throttling CPU and/or GPU usage), increasing or decreasing the memory (e.g., RAM) allocated to the AI agent, increasing or decreasing disk space allocated to the AI agent, increasing or decreasing bandwidth allocated to the AI agent, and/or the like. Modifying the access of an AI agent may comprise restricting (e.g., revoking or reducing) access by the AI agent to an application programming interface, restricting (e.g., revoking or reducing) access by the AI agent to at least one data source (e.g., third-party system 170, database 114, a database within integration environment 140, etc.), adjusting an authentication level required from the AI agent (e.g., requiring a higher level of authentication, such as adjusting from single-factor authentication to multi-factor authentication), revoking a credential of the AI agent (e.g., to thereby prevent access to one or more resources by the AI agent), downgrading at least one permission assigned to the AI agent (e.g., to thereby prevent the AI agent from performing an action that it was previously capable of performing), revoking access by the AI agent to one or more tools on platform 110 and/or third-party system 170, and/or the like. Adjusting the communication control of the AI agent may comprise limiting a rate by which the AI agent can call at least one application programming interface (e.g., to thereby prevent the AI agent from tying up the resources of the application programming interface), limiting a rate by which the application programming interface of the AI agent can be called, adjusting (e.g., increasing or decreasing) a response timeout for queries by the AI agent, adjusting (e.g., increasing or decreasing) a response time for queries to the AI agent, and/or the like.

Centralized governance system 330 may also define one or more decision patterns that may be used by module 360. The defined decision patterns may represent what anomalous behaviors module 360 is able to detect and how module 360 reacts to each anomalous behavior. For example, each decision pattern may comprise a pattern representing an anomalous behavior and a corrective action to be performed when that pattern is matched to the behavior of an AI agent. Thus, module 340 may detect the pattern in a decision pattern and responsively perform the associated corrective action.

Centralized governance system 330 may tune one or more predictive models, using the data collected for the registered AI agents. For example, the recommendation engine, which recommends AI agents to a user, as described elsewhere herein, may be trained and retrained using the data collected by centralized governance system 330 for all registered AI agents. Thus, the recommendation engine may improve over time, as the collected data grow and improve. Additionally or alternatively, other predictive models may be tuned using the data collected for the registered AI agents. For example, an AI model for suggesting the next step in an integration process 160 under construction, is described in U.S. Pat. No. 11,886,965, issued on Jan. 30, 2024, which is hereby incorporated herein by reference as if set forth in full. Such an AI model may be trained to suggest connector steps, representing a connection to a particular AI agent, based on historical data collected for the AI agents (e.g., representing their respective performances) by module 360.

Centralized governance system 330 may also define a reporting configuration for use with dashboard 350. The reporting configuration may define the periodicity of reports (e.g., once after each of a plurality of time intervals, such as hourly, daily, weekly, monthly, etc.), the layout and/or format of one or more screens of dashboard 350 representing the reports (e.g., the particular metrics to be visualized, the types of visual representations of those metrics, etc.), identifiers of users with access to the reports, critical alert criteria (e.g., defining one or more metrics and respective threshold(s) for those metric(s), which if satisfied, trigger an alert), notification preferences, and/or the like. Each report may comprise the value(s) of each of one or more metrics for each AI agent being monitored and for which the user, to which the report is directed, has responsibility. The value(s) for a given metric may comprise a time series of values for a past time window, forecasted value(s) for the metric for a future time window, and/or the like. The metrics may comprise the governance effectiveness index, described elsewhere herein, and/or any other metric of the AI agent's performance (e.g., computational performance), compliance with protocols, standards, and guardrails (e.g., ethical guardrails), abnormal behaviors, and/or the like. The reporting configuration may be user-defined, and therefore, specific to each user. Centralized governance system 330 may automatically generate reports according to the respective reporting configurations.

One of the metrics that may be used for reporting is a governance effectiveness index (GEI). In particular, centralized governance system 330 may, for at least one, and preferably each, of the plurality of AI agents in the registry, determine a governance effectiveness index for that AI agent via module 340. The governance effectiveness index may be computed, by module 340, for an AI agent, periodically (e.g., at the expiration of each of a plurality of time intervals, such as hourly, daily, weekly, monthly, etc.) and/or in response to another trigger, such as a user operation (e.g., a user requesting a value of the governance effectiveness index within user interface 150), system event, and/or the like.

Traditional methods for evaluating governance effectiveness are fragmented and incomplete, focusing on isolated aspects, such as risk assessment, compliance, or ethical considerations. This narrow approach fails to capture the full complexity and interdependence of AI systems and their governance structures. Thus, in an embodiment, the governance effectiveness index may quantify an effectiveness of governance of each AI agent across a plurality of dimensions. In particular, module 340 may compute the governance effectiveness index for a given AI agent, based on a measure of each of the plurality of dimensions. This holistic approach may combine quantitative metrics with qualitative assessments, utilizing a set of key dimensions, to provide a structured methodology for assessing the governance of AI agents comprehensively, in order to enhance decision-making, support continuous improvement, and align the artificial intelligence with broader organization objectives.

In a preferred embodiment, the plurality of dimensions comprises risk management, reliability, ethical alignment, performance, and security and privacy. This combination of dimensions represents a unique formula for measuring the effectiveness of governance of AI agents. However, it should be understood that this is simply one embodiment. In other embodiments, the plurality of dimensions may comprise more, fewer, or a different set of dimensions.

In any case, the governance effectiveness index may comprise or consist of a composite score derived from a combination of scores in each of the plurality of dimensions. The combination of scores may be an average, such as a weighted average, or a sum, such as a weighted sum. In the case of a weighted average or weighted sum, each dimension may be weighted, according to the weights defined in centralized governance system 330. Each weight may be a non-negative real number that defines the contribution of the respective dimension to the value of the governance effectiveness index, and, in an embodiment, all of the weights may sum to a value of one. The weights may be customized for a particular organizational account based on the specific risk landscape and governance focus areas within the associated organization.

In the preferred embodiment, module 340 may calculate the value of the governance effectiveness index, for an AI agent, according to or based on:

$$GEI = {w}_{1} \times RM + {w}_{2} \times RE + {w}_{3} \times EA + {w}_{4} \times PF + {w}_{5} \times SP$$

wherein w₁, w₂, w₃, w₄, and w₅ are the respective weights for the plurality of dimensions (e.g., which may sum to one), RM is a risk management score that quantifies an adequacy of the risk management strategy (e.g., risk identification, assessment, and/or mitigation) for the AI agent, RE is a reliability score that quantifies a reliability of the AI agent (e.g., consistency and/or accuracy in performing its task without errors), EA is an ethical alignment score that quantifies how well the AI agent adheres to ethical guidelines (e.g., fairness, bias minimization, etc.), PF is a performance score that quantifies a performance (e.g., efficiency and/or speed) of the AI agent in task execution, and SP is a security and privacy score that quantifies how well the AI agent is protected against data breaches and complies with privacy regulations.

The risk management score RM may be calculated according to:

$$RM = \frac{{R}_{m}}{{R}_{t}}$$

wherein Rₘ is the number of risks that were identified and mitigated by the AI agent, and Rₜ is the total number of potential risks applicable to the AI agent. These numbers may be collected by monitoring and analytics module 360.

The reliability score RE may be calculated according to:

$$RE = ( 1 - \frac{F}{O} )$$

wherein F is the number of failures of the AI agent, and O is the total number of operations performed by the AI agent. Again, these numbers may be collected by monitoring and analytics module 360. Notably, the reliability score RE represents an inverse measure of the failure rate of the AI agent.

The ethical alignment score EA may be calculated according to:

$$EA = ( 1 - \frac{V}{C} )$$

wherein V is the number of detected ethical violations by the AI agent, and C is the total number of ethical checks performed for the AI agent. Again, these numbers may be collected by monitoring and analytics module 360. Notably, the ethical alignment score EA represents an inverse measure of the ethical-violation rate of the AI agent.

The performance score PF may be calculated according to:

$$PF = \frac{{T}_{o}}{{T}_{a}}$$

wherein Tₒ is the baseline value (e.g., optimal) of a performance metric (e.g., computational time) for the AI agent, and Tₐ is the actual value of the performance metric by the AI agent. The baseline value of the performance metric may be determined from the specification of the AI agent and/or by module 320, whereas the actual value of the performance metric may be collected by monitoring and analytics module 360.

The security and privacy score SP may be calculated according to:

$$SP = ( 1 - \frac{I}{A} )$$

wherein I is the number of security incidents involving the AI agent, and A is the total number of attempted breaches and security or privacy assessments performed for the AI agent. Again, these numbers may be collected by monitoring and analytics module 360. Notably, the security and privacy score PF represents an inverse measure of the incident rate for the AI agent.

In an embodiment, each of the risk management score RM, reliability score RE, ethical alignment score EA, performance score PF, and security and privacy score SP may be a value between zero and one, and the governance effectiveness index may also be a value between zero and one. Alternatively, each of the risk management score RM, reliability score RE, ethical alignment score EA, performance score PF, and security and privacy score SP may be a value between zero and one, and the governance effectiveness index may be scaled to a value between zero and one-hundred, for example, by multiplying the value of GEI above by one hundred. As another alternative, each of the risk management score RM, reliability score RE, ethical alignment score EA, performance score PF, and security and privacy score SP may be a value between zero and one hundred (e.g., by multiplying the value of the respective score by one hundred), in which case the governance effectiveness index may also be a value between zero and one hundred.

In an embodiment, the governance effectiveness index has a time component. For example, the governance effectiveness index may be calculated at each of a plurality of time intervals, to produce a time series of values of the governance effectiveness index. In this case, an overall or composite value of the governance effectiveness index could be calculated based on the time series of governance effectiveness indices, for example, using weightings that weight more recent values of the governance effectiveness index over less recent values of the governance effectiveness index.

Dashboard 350 may display the reports generated by centralized governance system 330 within a graphical user interface of user interface 150. As discussed above, each report may comprise or otherwise indicate the value of each of one or more monitored metrics of the AI agents, including potentially the governance effectiveness index. In an embodiment, the report may be driven by artificial intelligence. For example, artificial intelligence may analyze the data collected for the AI agents, and automatically detect and convey new insights from the data, detect and highlight anomalies in the data, predict a trend for one or more metrics based on the data, filter the data based on priorities, summarize the data (e.g., using a large language model, or other generative language model), and/or the like.

Monitoring and analytics module 360 may, for each of the plurality of AI agents, after activation of the AI agent, monitor the AI agent in real time as the AI agent is executing. This monitoring may comprising an analysis 370 of each AI agent. Sub-module 371 may determine whether or not the AI agent is compliant with the governance policy with which it is associated in centralized governance system 330, and sub-module 372 may determine whether or not the AI agent is behaving anomalously according to one or more decision patterns defined in centralized governance system 330. For as long as the AI agent is compliant with the associated governance policy (i.e., “Yes” in sub-module 371) and the AI agent is not behaving anomalously (i.e., “No” in sub-module 372), sub-module 373 may label or maintain the label of the AI agent as trusted (e.g., by associating the AI agent with an indicator of trustworthiness). However, when determining that the AI agent is not compliant with the associated governance policy (i.e., “No” in sub-module 371) or is behaving anomalously (i.e., “Yes” in sub-module 372), sub-module 374 may automatically execute an appropriate corrective action, from the available corrective actions defined in centralized governance system 330, such as alerting a user, modifying an AI agent, adjusting an amount of each of one or more computational resources that is allocated to an AI agent, modifying an access of an AI agent to one or more systems, adjusting a communication control of the AI agent, and/or the like. In this case, sub-module 375 may also automatically label the AI agent as untrusted (e.g., by associating the AI agent with an indicator of untrustworthiness). In an alternative embodiment, analysis 370 may only perform compliance monitoring (i.e., sub-module 371) or only perform anomaly monitoring (i.e., sub-module 372).

As mentioned above, module 360 may track the value of each of one or more metrics for each of the plurality of AI agents, to be used by analysis 370 for determining compliance and anomalous behaviors, displayed in reports in dashboard 350, used by the recommendation engine of centralized governance system 330, and/or the like. These metrics may represent performance, resource utilization, ethical and data governance, compliance, risk, data handling, and/or the like. The performance metric(s) may quantify risk related to system downtime, failures, inaccuracies in AI decision-making that may disrupt business operations, and/or the like, and may comprise number of invocations of the AI agent, the number of invocation errors, the number of model-invocation errors, overhead latency, model latency, and/or the like. The metric(s) for resource utilization may quantify (e.g., as a percentage) the amount of each of one or more computational resources utilized by the AI agent, such as CPU utilization, GPU utilization, memory utilization, GPU memory utilization, disk utilization, and/or the like. The metric(s) for ethical and data governance may quantify the potential for the AI agent to produce biased and/or incorrect outputs due to biased training data and/or insufficient model training. The metric(s) for compliance may quantify the success or failure of the AI agent to adhere to the associated governance policy and/or guardrail(s), and may comprise a compliance score. The metric(s) for risk may utilize a risk framework or matrix (e.g., from NIST and/or ISO), which provide guidelines on conducting risk assessments, developing risk registers, and/or categorizing risks based on their natures and sources, to systematically quantify risks in the operation of the AI agent. The metric(s) for data handling may quantify the risks involved in the processing of PII data by the tool(s), utilized by the AI agent to engage with data sources (e.g., all channels by which the AI agent collects data, such as user interfaces, databases, application programming interfaces, sensors, etc.), and the potential implications for privacy.

Module 360 may itself comprise or utilize one or more governance AI agents to monitor and analyze the AI agents. In an embodiment, the governance AI agent(s), like any other AI agent, are included within the registry of centralized governance system 330. Alternatively or additionally, this governance AI agent(s) may be embedded within platform 110. A governance AI agent may interact with the logs (e.g., produced by Amazon Web Services CloudWatch™) of an AI agent being monitored and/or interact with the AI agent itself to determine one or more of the metrics tracked by module 360, including potentially one or more of the metrics utilized by module 340, such as the risk management score (e.g., RM), the reliability score (e.g., RE), the ethical alignment score (e.g., EA), the performance score (e.g., PF), and/or the security and privacy score (e.g., SP), and/or one or more constituent metrics used to calculate these scores. The governance AI agent(s) may operate on a periodic basis (e.g., after the expiration of each of a plurality of time intervals, such as hourly, daily, weekly, monthly, etc.) and/or in response to another trigger (e.g., a user operation, an update of dashboard 350, etc.).

In an embodiment, module 360 comprises or utilizes a governance AI agent to calculate the risk management score for a monitored AI agent. For example, the governance AI agent may query the monitored AI agent, via an application programming interface of the monitored AI agent, for the guardrail coverage of the monitored AI agent. In response, the monitored AI agent may generate a response, based on its guardrail configuration, and send the response to the governance AI agent. The governance AI agent may then calculate the risk management score based on the response from the AI agent.

In an embodiment, module 360 comprises or utilizes a governance AI agent to calculate the reliability score for a monitored AI agent. For example, the governance AI agent may analyze the logs for the monitored AI agent to compute the operands for the reliability score. The governance AI agent may also analyze conversational data to compute one or more operands for the reliability score. The governance AI agent may then calculate the reliability score for the monitored AI agent based on the computed operands.

In an embodiment, module 360 comprises or utilizes a governance AI agent to calculate the ethical alignment score for a monitored AI agent, such as an AI agent that utilizes a small or large language model. For example, the governance AI agent may generate and submit one or more prompts to the monitored AI agent, to invoke response(s) from the monitored AI agent. The governance AI agent may then assess the response(s) for bias, fairness, and/or the like, and quantify this assessment into the ethical alignment score for the monitored AI agent.

In an embodiment, module 360 comprises or utilizes a governance AI agent to calculate the performance score for a monitored AI agent. For example, the governance AI agent may analyze the logs for the monitored AI agent to compute the latency, error rate, and/or other operands of the performance score. The governance AI agent may then calculate the performance score for the monitored AI agent from these computed operands.

In an embodiment, module 360 comprises or utilizes a governance AI agent to calculate the security and privacy score for a monitored AI agent. For example, the governance AI agent may analyze the logs, related to guardrails, for the monitored AI agent, to compute the latency, error rate, and/or other operands of the security and privacy score, for a content policy, topic policy, sensitive-information policy, contextual-grounding policy, and/or the like of the governance policy assigned to the monitored AI agent. The governance AI agent may then calculate the security and privacy score for the monitored AI agent from these computed operands.

In an embodiment, module 360 comprises, utilizes, or itself is a governance AI agent that has access to one or more tools, including, for example, a knowledge base (e.g., including any of the data defined and/or stored by centralized governance system 330), frameworks for the available corrective actions, an explainability tool, and/or the like. Thus, for example, the governance AI agent may perform analysis 370, utilizing a knowledge base to determine whether or not a monitored AI agent is compliant (e.g., sub-module 371) and/or exhibiting anomalous behavior (e.g., sub-module 372), and utilizing the framework(s) (e.g., sub-module 374) to perform any corrective action (e.g., to recalibrate or deactivate a non-compliant or anomalously behaving monitored AI agent) and/or label the monitored AI agent (e.g., sub-modules 373 and/or 375), in real time. Each action by this governance AI agent may be logged, such that the governance AI agent is auditable and accountable. This log may also support explainability tools to ensure that actions, such as decision-making, data processing, and policy enforcement, are traceable and can be justified in line with legal and ethical expectations.

In summary, data flow 300 employs robust monitoring tools, featuring dynamic dashboards and AI-driven analytics, to provide real-time visibility into the activities of AI agents operating on platform 110. These tools may track critical parameters, such as a performance, resource utilization, decision patterns, outcome accuracy, and the like. The analytic capabilities enable early detection of anomalies, which allows proactive risk mitigation and timely interventions. AI agents can be assessed for biases, failure points, and unauthorized actions, thereby improving transparent decision-making.

In addition, a suite of predefined ethical norms and data governance protocols ensure that AI agents adhere to both moral standards and legal regulations, such as GDPR and CCPA. These guidelines enforce strict data privacy protocols, especially in the handling of personally identifiable information. This ensures that AI agents, responsible for data processing, implement privacy-preserving techniques, such as differential privacy, data anonymization, and encryption. By automating compliance checks through specialized governance AI agents, the alignment of data usage with the applicable ethical standards and regulatory mandates can be continuously verified.

Furthermore, data flow 300 may utilize advanced profiling algorithms to continuously evaluate AI agents against a risk matrix and compliance benchmarks established by the NIST AI RMF, as well as GDPR and other regulatory frameworks, such as ISO 27001, HIPAA, and FERPA. Risk profiling may involve a multi-factor analysis that considers the AI agents' performances, potentials for bias, failure rates, and security risks. This ensures that AI agents are operating within regulatory mandates, and that any discrepancies trigger automatic alerts for intervention or recalibration. Special governance strategies may be implemented for AI agents involved in the processing of PII or other sensitive data.

Advantageously, the disclosed governance system provides enhanced visibility and control over the performance of AI agents, proactive risk identification and mitigation strategies, and streamlined compliance management. The governance system provides a framework for ethical and data governance policies that ensures compliance with legal regulations (e.g., GDPR, CCPA, etc.), and a risk-profiling and compliance-assessment framework that continuously evaluates AI agents against established benchmarks and triggers alerts upon discrepancies.

### 4. Process for Unified Governance

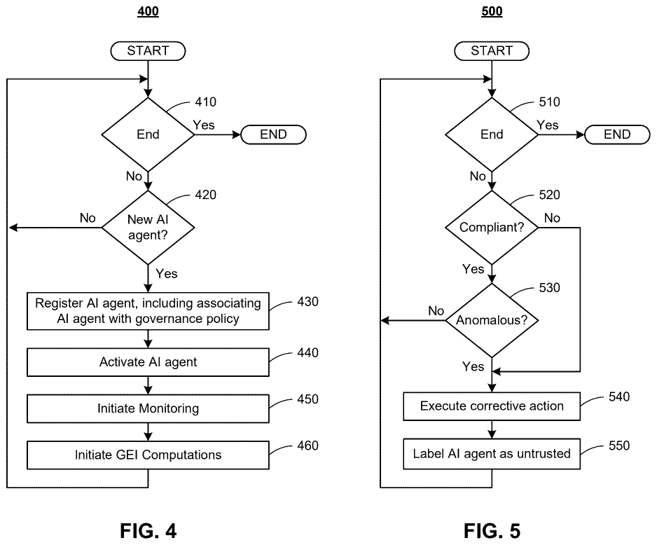

FIG. 4 illustrates a process for the unified governance of AI agents, according to an embodiment. Process 400 may be implemented in server application 112, for example, by centralized governance system 330. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 410 may determine whether or not to end process 400. Subprocess 410 may determine to end process 400 when centralized governance system 330 is shut down. Otherwise, subprocess 410 may determine to continue process 400. When determining to end process 400 (i.e., “Yes” in subprocess 410), process 400 ends. Otherwise, when not determining to end process 400 (i.e., “No” in subprocess 410), process 400 proceeds to subprocess 420.

Subprocess 420 may determine whether or not a new AI agent is to be registered in centralized governance system 330. For example, data for a newly available AI agent (e.g., on platform 110 or a third-party system 170, obtained via web crawling, etc.) may be integrated and configured by module 320 and provided to centralized governance system 330 for registration. The data may comprise the specification of the AI agent. When no AI agent is awaiting registration (i.e., “No” in subprocess 420), process 400 may return to subprocess 410 to wait for either process 400 to end or a new AI agent to be registered. Otherwise, when a new AI agent is awaiting registration (i.e., “Yes” in subprocess 420), process 400 may proceed to subprocess 430.

Subprocess 430 may register the AI agent in the registry of centralized governance system 330. This registration may comprise adding data about the AI agent to the registry, including an identifier of the AI agent, a network address of the AI agent, one or more parameters of the AI agent, an identifier of a standardized connector framework determined by module 320 for the type of AI agent, and/or the like. In addition, the registration may include associating the AI agent with a governance policy. The governance policy may be associated with the AI agent automatically, based on one or more attributes (e.g., type) of the AI agent, or manually based on one or more user inputs.

Subprocess 440 may activate the AI agent. In particular, subprocess 440 may enable AI agent to operate on platform 110, which may be an iPaaS platform. Prior to activation, an AI agent may be blocked from operating on platform 110 or may be capable of operating on platform 110 but in an unregistered and/or unsupported capacity. Once activated, users may be able to utilize the AI agent according to its function (e.g., integrate the AI agent into an integration process 160, directly query the AI agent, utilize the AI agent as a tool to perform a given task, etc.).

Subprocess 450 may, after activation of the AI agent, initiate continuous or continual monitoring of the AI agent, by module 360, in real time as the AI agent is executing. As described elsewhere herein, this monitoring may comprise analysis 370, which labels the AI agent as trusted or untrusted based on whether or not the AI agent remains compliant with the associated governance policy and/or does not exhibit anomalous behavior.

Subprocess 460 may, after activation of the AI agent, initiate computations of the governance effectiveness index by module 340. For example, module 340 may, periodically or in response to some other trigger, calculate a value of the governance effectiveness index for the AI agent. This governance effectiveness index may be used to quantify the effectiveness of the governance of the AI agent in reports (e.g., within dashboard 350) and/or for use by other systems (e.g., to train one or more predictive AI models). After full activation of the AI agent, process 400 may return to subprocess 410 to wait for either process 400 to end or a new AI agent to be registered.

### 5. Process for Monitoring AI Agents

FIG. 5 illustrates a process for monitoring AI agents, according to an embodiment. Process 500 may be implemented in server application 112, for example, by monitoring and analytics module 360. It should be understood that process 500 represents an embodiment of the monitoring initiated by subprocess 450. Thus, an instance of process 500 may be executed for each AI agent that has been registered according to process 400. Process 500 may itself be implemented as governance AI agent. While process 500 is illustrated with a certain arrangement and ordering of subprocesses, process 500 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 510 may determine whether or not to end process 500. Subprocess 510 may determine to end process 500 when monitoring and analytics module 360 is shut down. Otherwise, subprocess 510 may determine to continue process 500. When determining to end process 500 (i.e., “Yes” in subprocess 510), process 500 ends. Otherwise, when not determining to end process 500 (i.e., “No” in subprocess 510), process 500 proceeds to subprocess 520.

Subprocess 520, which may be implemented by sub-module 371, may determine whether or not the AI agent is compliant with the associated governance policy, which may comprise at least one data privacy protocol, at least one compliance standard, at least one privacy technique, and/or the like. In particular, subprocess 520 may retrieve the governance policy associated with the AI agent, compare the performance of the AI agent to the governance policy, which may define one or more rules or criteria, and determine whether or not the AI agent is compliant or non-compliant with the governance policy based on the comparison (e.g., whether the AI agent's operation follows the rules, satisfies the criteria, etc.). The comparison may comprise comparing the value of each of one or more compliance metrics to one or more thresholds. When satisfying the threshold(s), the AI agent may be determined to be compliant, and when not satisfying the threshold(s), the AI agent may be determined to be non-compliant. The compliance metric(s) may comprise any metric that quantifies an aspect of the governance policy, and may potentially include the governance effectiveness index, described elsewhere herein. Examples of compliance metrics include, without limitation, a rate of risks identified and mitigated to total risks, a failure rate, a rate of ethical violations, a ratio of an actual value of a performance metric (e.g., computational time) to a baseline value of the performance metric (e.g., as determined by module 320), a rate of security incidents, and the like. When the AI agent is determined to be compliant (i.e., “Yes” in subprocess 520), process 500 may proceed to subprocess 530. Otherwise, when the AI agent is determined to be non-compliant (i.e., “No” in subprocess 520), process 500 may proceed to subprocess 540.

Subprocess 530, which may be implemented by sub-module 372, may determine whether or not the AI agent is exhibiting anomalous behavior, as represented by one or more decision patterns defined by centralized governance system 330. In particular, subprocess 530 may retrieve the decision pattern(s) associated with the AI agent, compare each pattern in each decision pattern to the behavior of the AI agent, and determine whether or not the AI agent is exhibiting anomalous behavior based on the comparison. A pattern may comprise the values of a set of metrics, the profile of a time series of values for each of one or more metrics, a series of actions performed by an AI agent, and/or the like, that represent anomalous behavior or normal behavior. The comparison may comprise any suitable pattern-matching technique. When matching a pattern (if the patterns represent anomalous behavior) or when not matching a pattern (if the patterns represent normal behavior), the AI agent may be determined to be exhibiting anomalous behavior. Otherwise, the AI agent may be determined to not be exhibiting anomalous behavior. When the AI agent is determined to be exhibiting anomalous behavior (i.e., “Yes” in subprocess 530), process 500 may proceed to subprocess 540. Otherwise, when the AI agent is determined to not be exhibiting anomalous behavior (i.e., “No” in subprocess 530), process 500 may return to subprocess 510.

Subprocess 540, which may be implemented by sub-module 374, may automatically execute a corrective action. In the case of non-compliance with the governance policy (i.e., “Yes” in subprocess 520), the corrective action may be selected, from among the available corrective actions defined in centralized governance system 330, based on the particular data privacy protocol(s), compliance standard(s), privacy technique(s), and/or the like that have been violated. For instance, each particular protocol, standard, and technique may be associated, in centralized governance system 330, with a corrective action to be performed, and subprocess 540 may identify and execute the corrective action associated with each violated protocol, standard, and technique. In the case of anomalous behavior (i.e., “Yes” in subprocess 530), the corrective action may be identified as the corrective action for the matched decision pattern. In either case, as discussed elsewhere herein, the corrective action may comprise alerting a user, modifying an AI agent, adjusting an amount of each of one or more computational resources that is allocated to an AI agent, modifying an access of an AI agent to one or more systems, adjusting a communication control of the AI agent, and/or the like.

Subprocess 550, which may be implemented by sub-module 375, may label the AI agent as untrusted. For example, each AI agent may be associated with a label that has a binary value indicating either trusted or untrusted. Alternatively, the label may have a ternary value indicating either trusted, untrusted, or undetermined. In this ternary case, the label may be initialized to undetermined, and the label may be updated to either trusted (e.g., by sub-module 373) or untrusted (e.g., by sub-module 375) after the data, collected for the AI agent, have reached a sufficient volume to make a determination. In this case, analysis 370 may be initiated after the sufficient volume of data has been collected, after AI agent has been operational for a certain period of time, and/or the like.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
associate each of a plurality of artificial intelligence (AI) agents with a respective governance policy, prior to activation of the AI agent within an integration platform as a service (iPaaS) platform; and
for each of the plurality of AI agents, after activation of the AI agent, monitor the AI agent, in real time as the AI agent is executing, by
determining whether or not the AI agent is compliant with the associated respective governance policy, and
when determining that the AI agent is not compliant with the associated respective governance policy, automatically executing a corrective action, and labeling the AI agent as untrusted.

2. The method of claim 1, further comprising using the at least one hardware processor to, for each of the plurality of AI agents, monitor the AI agent, in real time as the AI agent is executing, by further:
determining whether or not the AI agent is behaving anomalously; and
when determining that the AI agent is behaving anomalously, automatically executing the corrective action, and labeling the AI agent as untrusted.

3. The method of claim 1, further comprising using the at least one hardware processor to, for each of the plurality of AI agents, determine a value of a governance effectiveness index that quantifies an effectiveness of governance of the AI agent across a plurality of dimensions.

4. The method of claim 3, wherein the plurality of dimensions comprises risk management, reliability, ethical alignment, performance, and security and privacy.

5. The method of claim 4, wherein, for each of the plurality of AI agents, determining the value of the governance effectiveness index comprises calculating the value of the governance effectiveness index according to:
$${w}_{1} \times RM + {w}_{2} \times RE + {w}_{3} \times EA + {w}_{4} \times PF + {w}_{5} \times SP$$
wherein w₁, w₂, w₃, w₄, and w₅ are weights, RM is a risk management score that quantifies an adequacy of a risk management strategy for the AI agent, RE is a reliability score that quantifies a reliability of the AI agent, EA is an ethical alignment score that quantifies how well the AI agent adheres to ethical guidelines, PF is a performance score that quantifies a performance of the AI agent in task execution, and SP is a security and privacy score that quantifies how well the AI agent is protected against data breaches and complies with privacy regulations.

6. The method of claim 1, further comprising using the at least one hardware processor to, for each type of the plurality of AI agents, generate a standardized connector framework for the generation of connector steps to be used by integration processes on the iPaaS platform to communicate with any one of the plurality of AI agents of that type.

7. The method of claim 1, wherein at least one of the respective governance policies comprises at least one data privacy protocol.

8. The method of claim 1, wherein at least one of the respective governance policies comprises at least one compliance standard.

9. The method of claim 1, further comprising using the at least one hardware processor to, for each of the plurality of AI agents, establish a baseline value for each of one or more performance metrics for the AI agent.

10. The method of claim 1, wherein the corrective action comprises modifying the AI agent.

11. The method of claim 10, wherein modifying the AI agent comprises one or more of:
terminating execution of the AI agent;
deactivating the AI agent;
adjusting at least one parameter of the AI agent;
detecting and correcting a bias in the AI agent; or
rolling back the AI agent to a previous version.

12. The method of claim 1, wherein the corrective action comprises adjusting an amount of each of one or more computational resources that is allocated to the AI agent.

13. The method of claim 1, wherein the corrective action comprises modifying an access of the AI agent to one or more systems.

14. The method of claim 13, wherein modifying the access of the AI agent to one or more systems comprises one or more of:
restricting access by the AI agent to an application programming interface;
restricting access by the AI agent to at least one data source;
adjusting an authentication level required from the AI agent;
revoking a credential of the AI agent; or
downgrading at least one permission assigned to the AI agent.

15. The method of claim 1, wherein the corrective action comprises adjusting a communication control associated with the AI agent.

16. The method of claim 15, wherein adjusting the communication control of the AI agent comprises one or more of:
limiting a rate by which at least one application programming interface can be called; or
adjusting a response timeout associated with the AI agent.

17. A system comprising:
at least one hardware processor; and
software that is configured to, when executed by the at least one hardware processor,
associate each of a plurality of artificial intelligence (AI) agents with a respective governance policy, prior to activation of the AI agent within an integration platform as a service (iPaaS) platform, and
for each of the plurality of AI agents, after activation of the AI agent, monitor the AI agent, in real time as the AI agent is executing, by
determining whether or not the AI agent is compliant with the associated respective governance policy, and
when determining that the AI agent is not compliant with the associated respective governance policy, automatically executing a corrective action, and labeling the AI agent as untrusted.

18. A non-transitory computer-readable medium having instructions stored therein, wherein the instructions, when executed by a processor, cause the processor to:
associate each of a plurality of artificial intelligence (AI) agents with a respective governance policy, prior to activation of the AI agent within an integration platform as a service (iPaaS) platform; and
for each of the plurality of AI agents, after activation of the AI agent, monitor the AI agent, in real time as the AI agent is executing, by
determining whether or not the AI agent is compliant with the associated respective governance policy, and
when determining that the AI agent is not compliant with the associated respective governance policy, automatically executing a corrective action, and labeling the AI agent as untrusted.
